(19) United States
(12) Patent Application Publication
(10) Pub. No.: US 2007/0202927 A1
(43) Pub. Date: Aug. 30, 2007

(54) Automated search and rescue call generation to mobile phones in a defined geographic disaster area

(76) Inventors: Gerald W. Pfleging, Batavia, IL (US); George P. Wilkin, Bolingbrook, IL (US)

Correspondence Address: PATTI , HEWITT & AREZINA LLC, ONE NORTH LASALLE STREET, 44TH FLOOR, CHICAGO, IL, 60602, US

(21) Appl. No.: 11/364,317

(22) Filed: Feb. 28, 2006

(51) Int. Cl. H04B 1/38

(52) U.S. Cl. 455/567; 455/404.1

(57) ABSTRACT

An apparatus and method are provided that receives locations of mobile phones in an area under a pending or current disaster/evacuation notice, and automatically generates calls to the mobile phones. Upon contacting the mobile phone user, automated voice inquires verify the location of the mobile phone user and determine the condition of the mobile phone user. Afterwards, responses to the automated voice inquires are stored and forwarded to emergency assistance agencies outside of the affected area. The locations of the mobile phones and a corresponding identity of the mobile phone users may be electronically displayed on a map utilized by emergency personnel in a rescue operation.

### TECHNICAL FIELD

This invention relates to the art of mobile phone handsets, and more particularly to automatically calling mobile phone handsets located in disaster areas.

### BACKGROUND

During a natural disaster, e.g., hurricane, flood, wildfire, earth quake, etc., or other emergency condition, e.g., explosions, hazardous spills, etc., many people may be trapped or unable to leave areas where a problem has occurred or will occur. Many of these people may have access to cellular or other types of wireless communications devices. The people with these devices may attempt to use their devices to call a) government authorities for assistance, e.g., 911 emergency centers, b) relatives, friends, or co-workers located in areas outside of the affected area, i.e., an area currently under pending or current disaster/evacuation notice, to advise them of their condition, or c) television and radio stations that might be able to contact other agencies to provide assistance. Disadvantageously, the people located in the disaster area may not be able to contact other people outside of the disaster area for assistance due to network overload conditions. Also, disadvantageously, the government authority sites that would normally respond to emergency calls may be un-staffed, otherwise made unusable, or out of commission.

One prior art system notifies people in specific areas of impeding emergencies. A reverse 911 notification system notifies residents and businesses located in predetermined geographical areas about a potential emergency condition via a) a telephone call with a recorded voice message, b) a text message, c) an electronic mail message or d) a fax. These are one-way systems that send information out. These systems are used prior to an emergency to simply warn people rather than being used before or after the emergency to contact and assist in rescuing people. Disadvantageously, many of these systems are unable to notify people with unlisted and non-published telephone numbers, because many of these systems are supplied with data from local telephone directories or the wire-line Enhance 911 (E911) telephone database, which associates a physical address with a calling party's telephone number.

### SUMMARY

It has been recognized, in accordance with the principles of the invention, that the problems of the prior art can be overcome by an automated search and rescue call generation system. More specifically, the automated search and rescue call generation system assists in emergency management by a) receiving an alert corresponding to an existence of an emergency in a defined area, wherein the defined area is an area under a disaster/evacuation notice, b) receiving locations of mobile phones situated in the defined area, wherein received locations of the mobile phones are stored and periodically updated, c) determining which mobile phones to call as a function of the received locations and stored telephone numbers of registered mobile phones in the defined area, and d) transmitting at least one signal to generate calls to the mobile phones situated in the defined area to determine a circumstance of each mobile phone user.

### DESCRIPTION OF THE DRAWINGS

FIG. 1 shows a network view of an illustrative embodiment of the present invention of an automated search and rescue call generation system;

FIG. 2 shows an illustrative flow chart for a method of operating the automated search and rescue call generation system; and

FIG. 3 shows an illustrative embodiment of a media application server.

### DETAILED DESCRIPTION

An emergency condition is any highly dangerous situation or occurrence that happens unexpectedly and requires immediate remedial action. Natural disasters, e.g., hurricane, flood, wildfire, earth quake, etc., and man-made disasters, e.g., explosions, hazardous spills, etc., are illustrative of emergency conditions. The automated search and rescue call generation system may assist rescuers in locating and contacting people in such emergency conditions.

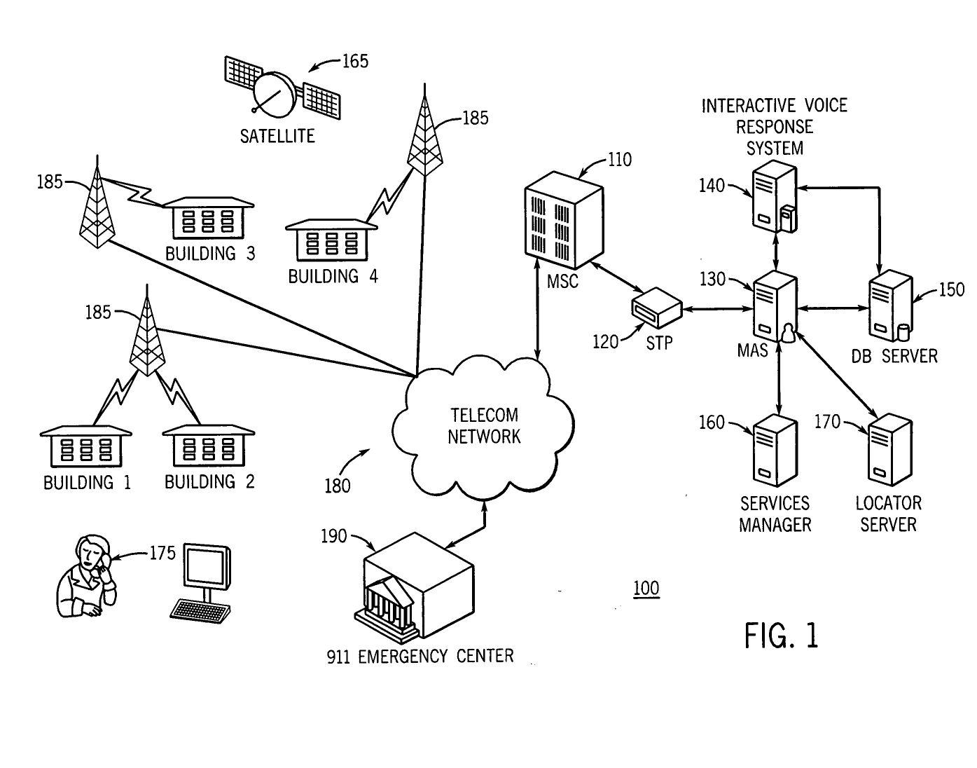

FIG. 1 is a block diagram illustrating an automated search and rescue call generation system arranged in accordance with the principles of the invention. As shown in FIG. 1, the automated search and rescue call generation system 100 includes mobile switching center (MSC) 110, signal transfer point (STP) 120, Media Application Server (MAS) 130, interactive voice response server 140, database (DB) server 150, services manager 160, and locator server 170. Also, shown in FIG. 1 are global positioning system (GPS) satellite 165, mobile phone 175, telecom network 180, mobile phone transmission towers 185, and 911 Emergency Center 190.

MSC 110 is a telecommunications switch capable of switching calls between a plurality of endpoints via a wireless network connected to a public switched telephone network (PSTN), e.g., telecom network 180. MSC 110 monitors all mobile phone calls within its serving area, tracks the location of all mobile phone-equipped vehicles traveling within its service area, arranges handoffs between switches, keeps track of billing information, etc. In one embodiment of the invention, when the automated search and rescue call generation system receives notification of an emergency, MSC 110 calls any mobile phones, e.g., mobile phone 175, registered with or to MSC 110 that are located in an area where a disaster has occurred. In another embodiment of the invention, when the automated search and rescue call generation system receives notification of an emergency, MSC 110 calls mobile phones registered to MSC 110 that are located in only a specific neighborhood prior to or after an emergency. In yet another embodiment of the invention, when the automated search and rescue call generation system receives notification of an emergency, MSC 110 calls mobile phones registered to MSC 110 that are part of a specific group, e.g. Company A employees.

MSC 110 may attempt to contact each mobile phone user a predetermined number of attempts. The predetermined number of attempts may be set to a specific length of time or a specific number of rings. If MSC 110 cannot contact the mobile phone user after a predetermined number of attempts, then MSC 110 may call the telephone numbers for other mobile phone users in the disaster affected area.

MSC 110 may give calls from the affected area a first priority on the switch, and adjust resources as necessary to provide this capability for as long as possible. MSC 110 is connected to MAS 130, and STP 120. MSC 110, in one embodiment, comprises one or more of a 5ESS® 2000—Switch Mobile Switching Centre (MSC) (Lucent Technologies).

STP 120 is a packet switch that routes signaling messages on a signaling system 7 (SS7) network. STP 120 may be used to route signaling messages between MSC 110, MAS 130, interactive voice response server 140, DB server 150, services manager 160, and locator server 170.

MAS 130 controls any applications needed for a telephone call after a trigger of an emergency has been received. Upon receiving the trigger, MAS 130 a) determines which mobile switching center, e.g., MSC 110, serves the affected area, b) determines which mobile phones are registered to that MSC and are located in the affected area, c) retrieves the telephone numbers of the mobile phone users from a storage device, e.g., DB server 150, and d) signals the mobile switching center, e.g., MSC 110, to call the telephone numbers in the affected area. MAS 130, in one embodiment, comprises one or more of a MiLife® Application Server (Lucent Technologies). MAS 130 is connected to MSC 110, services manager 160, interactive voice response server 140, DB server 150, and locator server 170.

Interactive voice response server 140 provides interactive voice messages and announcements to mobile phone users after MSC 110 has contacted the mobile phone users. Upon being connected to a powered on mobile phone, interactive voice response server 140 may warn the mobile phone users via an announcement of an impending emergency. Also, interactive voice response server 140 may ask the mobile phone users, via a human sounding automated voice, a series of questions to which the mobile phone users may respond to assist rescuers in determining the condition of the mobile phone users before or after a disaster, thereby overcoming the one-way announcement limitations of the prior art. Illustratively, after a disaster, interactive voice response server 140 may inquire, a) “Are you injured?”, b) “How many people are at your location?”, c) “Do you need help in evacuating?”, d) “Can you verify the address of your current location?”, e) “Do you have food and water?”, and f) “Are you on medication or life prolonging machines?”.

The response to these questions may be answered by either a voice response or by pressing keys on the mobile phone handset. In one embodiment of the invention, interactive voice response server 140 may use voice recognition to determine when the mobile phone users have completed their voice responses. In another embodiment of the invention, interactive voice response server 140 may have a menu-driven program which recognizes responses made by pressing the keys on the mobile phone, e.g., “Press 1 if you are trapped and need assistance.”. Interactive voice response server 140 may play an announcement informing each mobile phone user that authorities have been contacted after the mobile phone user has finished responding to the questions.

After interactive voice response server 140 collects the responses, interactive voice response server 140 may signal MAS 130 to communicate the information, i.e., the locations of the mobile phone respondents, the identities of the mobile phone respondents, and their responses, to government authority sites, e.g., 911 Emergency Center 190 or other agencies responsible for rescuing the mobile phone users, outside of the affected area. In one embodiment of the invention, the automated search and rescue call generation system transmits a Transmission Control Protocol/Internet Protocol (TCP/IP) message with mapping data of the mobile phone users' locations, identities, and the mobile phone users' responses. In another embodiment of the invention, the automated search and rescue call generation system transmits the information by calling a predetermined telephone number. An IP address and/or the predetermined telephone number of the agency may be stored in a storage device, e.g., DB server 150. Upon receiving the information, the locations of the mobile phones in the affected area and the identities of the mobile phone users could be electronically displayed on a map utilized by emergency personnel in a rescue operation. The map could be updated as each mobile phone user moves from the affected area.

Also, interactive voice response server 140 may forward the information, i.e., mapping data of the mobile phone users' locations, the mobile phone users' identity and the mobile phone users' responses, to the storage device, e.g., DB server 150. Interactive voice response server 140 is connected to MAS 130 and DB server 150. Interactive voice response server 140, in one embodiment, comprises one or more of an Enhanced Media Resource Server (eMRS) (Lucent Technologies).

DB server 150 stores and manages subscriber records, e.g., telephone numbers, addresses, etc. DB server 150 may provide the telephone numbers of the mobile phones that MSC 110 may call during an emergency. Also, in an intelligent network (IN) environment, DB server 150 may store state information that the automated search and rescue call generation system needs when a specific request is made, e.g., use menu-drive response function for the mobile phone user. Furthermore, DB server 150 may store the responses of the mobile phone users, which were collected by interactive voice response server 140, along with the mapping data of the location of each respondent.

Data stored in DB server 150 may be organized so that when information identifying a particular request is presented, the corresponding set of records may be retrieved. In one embodiment of the invention, DB server 150 may retrieve telephone numbers for every mobile phone registered to MSC 110 in the affected area. In another embodiment of the invention, DB server 150 may retrieve telephone numbers for every mobile phone registered to MSC 110 in the affected area for a specific group, e.g., Company A employees. In yet another embodiment of the invention, DB server 150 may retrieve telephone numbers for every mobile phone registered to MSC 110 for a particular neighborhood or area.

The subscriber records used to populate DB server 150 may be supplied by a home location register (HLR), a visiting location register (VLR), or other sources. DB server 150 may be stored local to interactive voice response server 140, or remote therefrom. DB server 150 is connected to interactive voice response server 140 and MAS 130.

Services manager 160 provides operations, administration, maintenance and provisioning (OAM&P) support for MAS 130. Service manager 160 may receive an external trigger, i.e., alert, that corresponds to a notification of an impending disaster. The external trigger may be received as a TCP/IP message or other messaging protocol from a government agency, e.g., National Oceanic & Atmospheric Administration or other government agency. After receiving the trigger, services manager 160 forwards the trigger to MAS 130. Services manager 160, in one embodiment, comprises one or more of an Enhanced Services Manager (eSM) (Lucent Technologies).

Rescuers may not know the exact location of the people needing assistance. Locator server 170 uses techniques that are well known in the art to determine the location of mobile phones within the range of a mobile switching center, e.g., MSC 110. Locator server 170 maps the locations of mobile phones using two or three dimensional coordinates, e.g., longitude, latitude, and altitude, and a corresponding identity, e.g., telephone number, subscriber name, etc., of each mobile phone. After locating the mobile phones, locator server 170 may periodically track and update the location of each mobile phone. This feature may provide rescuers an indication of whether the mobile phone user has moved outside of the affected area. The location and identity information may be stored for a predetermined amount of time, which is controlled and adjustable by a service provider.

In one embodiment of the invention, locator server 170 may use triangulation with mobile phone transmission towers, e.g., transmission towers 185, to determine the location of the mobile phones registered to MSC 110 in an area currently under pending or current disaster/evacuation notice. In this embodiment, the time delay of signals from the mobile phone to three different mobile phone transmission towers provides the location of the mobile phone. In another embodiment of the invention, locator server 170 may use a global positioning system (GPS), e.g., GPS satellite 165, to determine the location of the mobile phones registered to MSC 110 in an area currently under pending or current disaster/evacuation notice. In this embodiment, a GPS receiver may be embedded in the mobile phone receiver to determine the location of the mobile phone.

In one embodiment of the invention, locator server 170 may be implemented as an application on a server. In another embodiment of the invention, Locator server 170 may be implemented as an application on a media application server, e.g., MAS 130. Locator server 170 is connected to MAS 130.

Those of ordinary skill in the art will readily be able to select MSCs, STPs, data bases and servers appropriate for use in any particular implementation of the automated search and rescue call generation system.

Advantageously, rescuers may now identify where a large concentration of mobile phone users are located within the range of the mobile switching center prior to or subsequent to a natural disaster based on location information obtained and stored for the selected mobile phone users before mobile phone transmission towers are damaged. Rescuers may be able to contact the mobile phone users within that range to determine who may require immediate assistance, e.g., medical aid, and/or transportation from the affected area. After emergency assistance has been provided, authorities may send a message to the automated search and rescue call generation system to confirm the rescue so that the system may be updated.

Also, advantageously, mobile phone users in disaster areas within the range of the mobile switching center may be contacted even when government authority sites that would normally respond to emergency calls are un-staffed or out of commission. Further, advantageously, even mobile phone users with unlisted and non-published telephone numbers may be located and contacted.

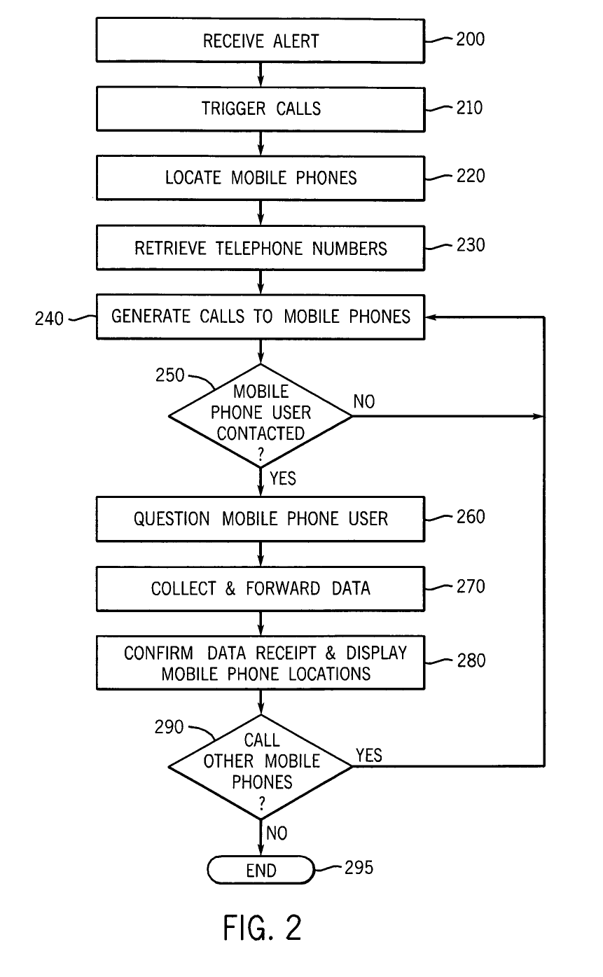

FIG. 2 shows a flow chart of the operation of the automated search and rescue call generation system in accordance with the principles of the present invention. The process is entered in step 200 when an alert has been received of an existence of an emergency condition in an affected area. The alert may be received as a) a message to services manager 160 (FIG. 1) or b) a telephone call from a government agency to a private telephone number for MSC 110.

In step 210 (FIG. 2), the message is sent to MAS 130 (FIG. 1) by service manager 160 or by MSC 110. This trigger signals MAS 130 that an event has occurred in the area served by MSC 110, and to change its provisioning to begin to identify mobile phones in the affected area.

In step 220 (FIG. 2), MAS 130 (FIG. 1) signals locator server 170 via STP 120 to map the locations of the registered mobile phones in the affected area. Locator server 170 determines the locations of registered mobiles phones in the affected area via triangulation of mobile phone transmission towers or via a global positioning system and sends the location information to MAS 130 and DB server 150 via STP 120. The locations of the registered mobiles phones are tracked and periodically updated.

In step 230 (FIG. 2), MAS 130 (FIG. 1) signals DB server 150 via STP 120 to provide telephone numbers of all mobile phone users registered to MSC 110. MAS 130 determines which telephone numbers correspond to the registered mobile phone users currently located in the affected area.

In step 240 (FIG. 2), MAS 130 (FIG. 1) signals MSC 110 via STP 120 to generate calls to the registered mobile phone users in the affected area, including mobile phone users with unlisted and un-published telephone numbers. MSC 110 generates calls to the mobile phone users, attempting to contact a powered on mobile phone user in the affected area. MSC 110 gives first priority to connecting calls from the mobile phones in the affected area.

In step 250 (FIG. 2), it is necessary to determine whether MSC 110 (FIG. 1) has contacted the powered on mobile phone user.

If the test result in conditional branch point 250 (FIG. 2) is NO, indicating that MSC 110 (FIG. 1) has not contacted the powered on mobile phone user, then control is passed to step 240 (FIG. 2). If the test result in step 250 is YES, indicating that MSC 110 (FIG. 1) has contacted the powered on mobile phone user, then control is passed to step 260.

In step 260 (FIG. 2), upon contacting the powered on mobile phone user, MSC 110 (FIG. 1) signals MAS 130 via STP 120 that a mobile phone user has been contacted. MAS 130 signals interactive voice response server 140 via STP 120 to play automated voice inquiries to verify the location of the mobile phone user and to determine the circumstance, e.g., medical condition, of the mobile phone user.

In step 270 (FIG. 2), interactive voice response server 140 (FIG. 1), signals DB server 150 via STP 120 to determine whether to collect voice responses or to collect menu-driven key pressed responses. DB server 150 replies to interactive voice response server 140 via STP 120. Interactive voice response server 140 a) collects the mobile phone user's responses to the automated voice inquiries, b) signals MAS 130 to send the locations, mobile phone user's identity and responses, via a TCI/IP message or by calling a predetermined telephone number, to government agencies located outside of the affected area, e.g., 911 Emergency Center 190, c) forwards the mobile phone user's identity and responses to DB server 150 for storing, and d) informs the mobile phone user that authorities have been contacted.

In step 280 (FIG. 2), the government agency confirms receipt of the information. The received locations and identities of the mobile phone users may be electronically display on a map utilized by emergency personnel.

In step 290 (FIG. 2), it is necessary to determine whether MSC 110 (FIG. 1) should call additional mobile phone users.

If the test result in conditional branch point 290 (FIG. 2) is YES, indicating that additional mobile phone users are powered on in the affected area and should be called, then control is passed to step 240. If the test result in conditional branch point 290 is NO, indicating that there are no additional mobile phone users that are powered on in the affected area, then control is passed to step 295.

The process is exited in step 295.

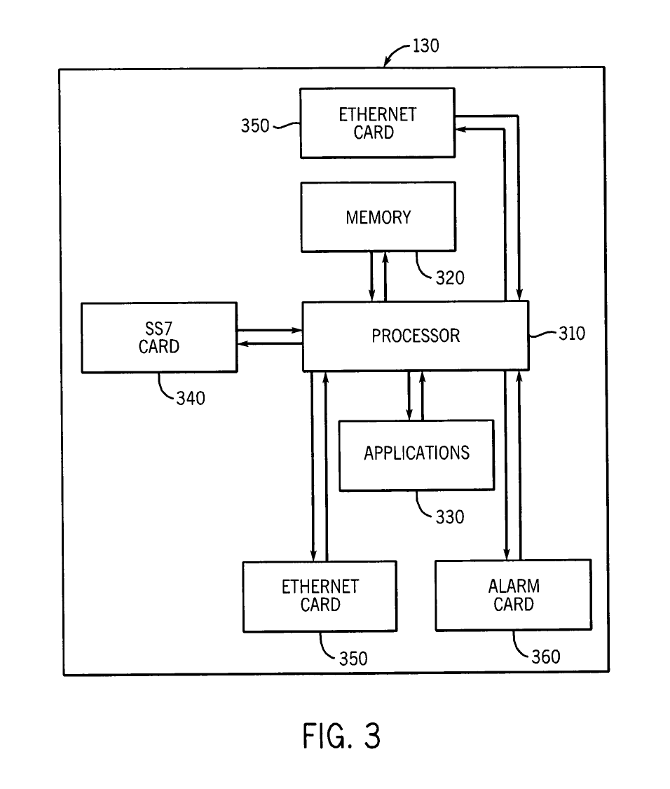

FIG. 3 shows an illustrative embodiment of a media application server, e.g., MAS 130. In FIG. 3, processor 310 is connected to memory 320, applications 330, SS7 card 340, Ethernet cards 350, and alarm card 360.

Processor 310 may be any type of processor capable of manipulating data and controlling the operation of MAS 130. Processor 310 should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. The functions of processor 310 may be provided by a single dedicated processor, by a single shared processor, or by a plurality of individual processors, some of which may be shared.

SS7 card 340 and Ethernet cards 350 are types of cards that may be used to access particular types of network elements with which MAS 130 wishes to communicate. Illustratively, when the network element is connected to a SS7 network, then the card may be SS7 card 340. Also, when the network element is connected to an IP network, then the cards may be Ethernet cards 350. SS7 card 340 and Ethernet cards 350 each contain transmitters, not shown, for transmitting information to network elements, and receivers, not shown, for receiving information from network elements.

Applications 330 are software modules that may be executed by hardware. Applications 330 are written in or implemented with any of a number of programming languages, as will be appreciated by those skilled in the art.

Memory 320 contains memory locations for storing information, such as software, and data.

Alarm card 360 provides alerts to Services manager 160 of conditions, e.g., malfunctions, failures, or other abnormal conditions, that may degrade the processing capabilities of MAS 130. Such alerts may ultimately require corrective action by maintenance personnel.

Those skilled in the art will recognize that embodiments of the invention that employ generating calls to wire-line telephones may be used. Illustratively, the mobile switching center may call wire-line telephones located in specific areas codes if the automated search and rescue call generation system has been configured to do so. Also, access to the location information could be provided to a web server that allows other people, e.g., relatives, friends, etc., having the mobile phone numbers of the mobile phone users to query the system to determine whether the mobile phone user has left the area and where the mobile phone users might be located.

The foregoing merely illustrates the embodiments of the invention. It will thus be appreciated that those skilled in the art will be able to devise various arrangements, which, although not explicitly described or shown herein, embody the principles of the invention, and are included within its spirit and scope.

What is claimed:

1. A method, comprising the steps of:
receiving an alert corresponding to an existence of an emergency in a defined area, wherein the defined area is an area under a disaster/evacuation notice;
receiving locations of mobile phones situated in the defined area, wherein received locations of the mobile phones are stored and periodically updated;
determining which mobile phones to call as a function of the received locations and stored telephone numbers of registered mobile phones in the defined area: and
transmitting at least one signal to generate calls to the mobile phones situated in the defined area to determine a circumstance of each mobile phone user.

2. The method of claim 1 wherein the defined area is served by at least one mobile switching center (MSC), and the MSC gives first priority to connecting calls from the mobile phones situated in the defined area.

3. The method of claim 1 wherein the transmitting at least one signal to generate calls step further comprises the steps of:
transmitting at least one signal to determine, via automated voice inquiries, the circumstance of each powered on mobile phone user upon being connected to each mobile phone;
collecting responses to the inquiries from each powered on mobile phone user; and
informing, via an automated voice message, each powered on mobile phone user that authorities have been contacted upon completion of the responses.

4. The method of claim 3 wherein each powered on mobile phone user responds to the automated voice inquiries via a technique selected from the group consisting of a) a voice response and b) pressing keys on the mobile phone handset.

5. The method of claim 3 further comprising the step of transmitting at least one signal to store the response from each powered on mobile phone user and identities of respondents.

6. The method of claim 1 further comprising the step of transmitting at least one signal to send information concerning each powered on mobile phone user to emergency assistance agency locations outside of the defined area, wherein the information comprises a) the location of the mobile phone, b) an identity of each powered on mobile phone user and c) the circumstance of each powered on mobile phone user.

7. The method of claim 6 wherein the step of transmitting at least one signal to send information further comprises the step selected from the group consisting of a) transmitting a Transmission Control Protocol/Internet Protocol (TCP/IP) message with the information and b) calling a predetermined telephone number and providing the information.

8. The method of claim 1 further comprising the step of transmitting at least one signal to electronically display the locations of the mobile phones and corresponding identities of mobile phone users on a map utilized by emergency personnel.

9. The method of claim 1 wherein mobile phone users with unlisted and non-published telephone numbers are located and contacted.

10. The method of claim 6 further comprising receiving a message from emergency assistance agency locations confirming that mobile phone users have been rescued.

11. A method of operating an automated search and rescue call generation system, the method comprising the steps of:
receiving, via a media application server (MAS), a trigger corresponding to an existence of an emergency in a defined area, wherein the defined area is an area under an emergency condition;
determining, via a locator server, locations of mobile phones situated in the defined area;
determining, via MAS, which mobile phones to call as a function of the location of the mobile phones and stored telephone numbers of registered mobile phones in the defined area;
generating, via a MSC, calls to the mobile phones situated in the defined area;
determining, via an interactive voice response server, a circumstance of each powered on mobile phone user upon being connected to each mobile phone;
storing, via a data base server, responses obtained from each powered on mobile phone user and the location of each powered on mobile phone user; and
sending information concerning each powered on mobile phone user to emergency assistance agency locations.

12. The method of claim 11 wherein the information comprises a) the location of the mobile phone user, b) an identity of each powered on mobile phone user and c) the circumstance of each powered on mobile phone user.

13. An apparatus, comprising:
means for receiving an alert corresponding to an occurrence of an emergency in a defined area, wherein the defined area is an area under a disaster/evacuation notice;
means for receiving locations of mobile phones situated in the defined area, wherein received locations of the mobile phones are stored and periodically updated;
means for determining which mobile phones to call as a function of the received locations and stored telephone numbers of registered mobile phones in the defined area; and
means for transmitting at least one signal to generate calls to the mobile phones situated in the defined area to determine a circumstance of each mobile phone user.

14. The apparatus of claim 13 wherein the defined area is served by at least one mobile switching center (MSC), and the MSC gives first priority to connecting calls from the mobile phones situated in the defined area.

15. The apparatus of claim 13 wherein the means for transmitting at least one signal to generate calls further comprises:
means for transmitting at least one signal to determine, via automated voice inquiries, the circumstance of each powered on mobile phone user upon being connected to each mobile phone;
means for collecting responses to the inquiries from each powered on mobile phone user; and
means for informing, via an automated voice message, each powered on mobile phone user that authorities have been contacted upon completion of the responses.

16. The apparatus of claim 15 wherein each powered on mobile phone user responds to the automated voice inquiries via a technique selected from the group consisting of a) a voice response and b) pressing keys on the mobile phone handset.

17. The apparatus of claim 13 further comprising means for transmitting at least one signal to send information concerning each powered on mobile phone user to emergency assistance agency locations outside of the defined area, wherein the information comprises a) the location of the mobile phone, b) an identity of each powered on mobile phone user and c) the circumstance of each powered on mobile phone user.

18. The apparatus of claim 17 wherein the means for transmitting at least one signal to send information is selected from the group consisting of a) means for transmitting a Transmission Control Protocol/Internet Protocol (TCP/IP) message with the information and b) means for calling a predetermined telephone number and providing the information.

19. The apparatus of claim 15 further comprising means for transmitting at least one signal to store the response from each powered on mobile phone user and identities of respondents.

20. The apparatus of claim 13 wherein mobile phone users with unlisted and non-published telephone numbers are located and contacted.
